(19) United States
(12) Patent Application Publication
(10) Pub. No.: US 2025/0356838 A1
(43) Pub. Date: Nov. 20, 2025

(54) METHOD, APPARATUS, DEVICE, MEDIUM AND PROGRAM PRODUCT FOR GENERATING ACOUSTIC FEATURES

(71) Applicants: Lemon Inc., Grand Cayman (KY); Beijing Zitiao Network Technology Co., Ltd., Beijing (CN)

(72) Inventors: Dongya Jia, Beijing (CN); Jian Cong, Beijing (CN); Zhuo Chen, Los Angeles, CA (US); Yuanzhe Chen, Beijing (CN); Zhengxi Liu, Beijing (CN); Jiawei Chen, Beijing (CN); Yuping Wang, Beijing (CN); Yuxuan Wang, Los Angeles, CA (US)

(21) Appl. No.: 19/207,502

(22) Filed: May 14, 2025

(30) Foreign Application Priority Data
May 15, 2024 (CN) 202410601973.4

(51) Int. Cl. G10L 13/033; G10L 13/027; G10L 13/08

(52) U.S. Cl. CPC G10L 13/033; G10L 13/027; G10L 13/08

(57) ABSTRACT

Embodiments of the present disclosure relate to a method, an apparatus, a device, a medium and a program product for generating acoustic features. The method comprises: acquiring a target text to be processed and a speech prompt having a target timbre. The method further comprises determining a text embedding based on the target text and a prompt text corresponding to the speech prompt. The method further comprises determining, based on prompt acoustic features corresponding to the speech prompt, a local timbre embedding corresponding to a plurality of feature frames of the prompt acoustic features. The method further comprises generating target acoustic features having the target timbre and corresponding to the target text based on the text embedding and the local timbre embedding.

### CROSS-REFERENCE TO RELATED APPLICATION(S)

This application claims priority to Chinese Application No. 202410601973.4 filed on May 15, 2024, the disclosures of which are incorporated herein by reference in their entities.

### FIELD

Embodiments of the present disclosure generally relate to the field of audio processing, and specifically to a method, an apparatus, a device, a medium and a program product for generating acoustic features.

### BACKGROUND

At present, machine learning plays an increasingly important role in daily production and life. Acoustic models based on deep learning in machine learning have also emerged. The acoustic models are widely applied in fields such as speech recognition, speech translation and speech synthesis. Furthermore, the acoustic models may not only process relevant tasks in combination with an audio, but also further process corresponding tasks in combination with multi-modal content such as a text or a video.

With the development of the acoustic models, they can be applied to fields such as speech recognition, speech synthesis, speech conversion, timbre customization, etc. Thus, the conventional acoustic models may perceive various sound signals such as a speech, an audio event, a human speech, a noise, timbre, etc. However, there are many problems to be solved during audio processing using acoustic models.

### SUMMARY

Embodiments of the present disclosure provide a method, an apparatus, a device, a medium and a program product for generating acoustic features.

According to a first aspect of the present disclosure, there is provided a method for generating acoustic features. The method comprises: acquiring a target text to be processed and a speech prompt having a target timbre. The method further comprises determining a text embedding based on the target text and a prompt text corresponding to the speech prompt. The method further comprises determining, based on prompt acoustic features corresponding to the speech prompt, a local timbre embedding corresponding to a plurality of feature frames of the prompt acoustic features. The method further comprises generating target acoustic features having the target timbre and corresponding to the target text based on the text embedding and the local timbre embedding.

According to a second aspect of the present disclosure, there is provided an apparatus for generating acoustic features. The apparatus comprises a target text and speech prompt acquisition module configured to acquire a target text to be processed and a speech prompt having a target timbre; a text embedding determination module configured to determine a text embedding based on the target text and a prompt text corresponding to the speech prompt; a local timbre embedding determination module configured to determine, based on prompt acoustic features corresponding to the speech prompt, a local timbre embedding corresponding to a plurality of feature frames of the prompt acoustic features; and target acoustic features generation module configured to generate target acoustic features having the target timbre and corresponding to the target text based on the text embedding and the local timbre embedding.

According to a third aspect of the present disclosure, there is provided an electronic device, comprising at least one processor; a storage device for storing at least one program which, when executed by the at least one processor, causes the at least one processor to implement the method in the first aspect of the present disclosure.

In a fourth aspect of the present disclosure, there is provided a computer readable storage medium having stored thereon a computer program which, when executed by a processor, implements the method in the first aspect of the present disclosure.

In a fifth aspect of the present disclosure, there is provided a computer program product. The computer program product comprises a computer program which, when executed by a processor, implements the method in the first aspect of the present disclosure.

It will be appreciated that the content described in Summary part is not intended to define essential or important features of embodiments of the present disclosure or to limit the scope of the present disclosure. Other features of the present disclosure will be made apparent by the following description.

### BRIEF DESCRIPTION OF THE DRAWINGS

The above and other objects, features and advantages of the present disclosure will become more apparent by reference to the following detailed description of example embodiments of the present disclosure in conjunction with the accompanying drawings, wherein the same reference numerals usually denote the same parts in the example embodiments of the present disclosure.

FIG. 1 illustrates a schematic diagram of an example environment in which apparatuses and/or methods according to embodiments of the present disclosure may be implemented;

FIG. 2 illustrates a schematic diagram of a flow chart of an example of generating acoustic features according to an embodiment of the present disclosure;

FIG. 3 illustrates a schematic diagram of an example method for generating acoustic features in accordance with an embodiment of the present disclosure;

FIG. 4 illustrates a schematic diagram of an example of a model for generating acoustic features in accordance with an embodiment of the present disclosure;

FIG. 5 illustrates a schematic diagram of an example of another model for generating acoustic features in accordance with an embodiment of the present disclosure;

FIG. 6 illustrates a schematic diagram of an example of a diffusion model based on a self-attention mechanism in a model for generating acoustic features in accordance with an embodiment of the present disclosure;

FIG. 7 illustrates a schematic diagram of an example of the training of a model for generating acoustic features in accordance with an embodiment of the present disclosure;

FIG. 8 illustrates a schematic diagram of an example of an overall architecture for generating a speech waveform according to an embodiment of the present disclosure;

FIG. 9 illustrates a schematic block diagram of an apparatus for generating acoustic features in accordance with an embodiment of the present disclosure;

FIG. 10 illustrates a schematic block diagram of an example device adapted for implementing embodiments of the present disclosure.

In the figures, the same or like reference numerals designate the same or like parts.

### DETAILED DESCRIPTION OF EMBODIMENTS

It may be appreciated that data (including but not limited to the data itself, acquisition or use of data) involved in the technical solution should comply with requirements in relevant laws and regulations and relevant provisions. In response to reception of the user's active request, prompt information is sent to the user to explicitly prompt the user that an operation he requests to perform needs to obtain and use the user's personal information. Accordingly, the user may autonomously select, according to the prompt information, whether to provide the personal information to software or hardware such as an electronic device, an application, a server or a storage medium, which executes the operations of the technical solution of the present disclosure.

Embodiments of the present disclosure will be described in more detail with reference to the accompanying drawings. While certain embodiments of the present disclosure have been illustrated in the accompanying drawings, it is to be understood that the present disclosure may be embodied in various forms and should not be construed as being limited to the embodiments set forth herein; rather, these embodiments are provided to enable the present disclosure to be understood more thoroughly and completely. It should be understood that the drawings and examples of the present disclosure are for illustrative purposes only and are not intended to limit the scope of the present disclosure.

In the description of the embodiments of the present disclosure, the term “include” or like words should be considered as being open-ended, i.e., “include but not limited to”. The term “based on” should be understood as meaning “based at least in part on”. The terms “one embodiment” or “the embodiment” should be understood as “at least one embodiment”. The terms “first”, “second” and the like may refer to different or identical objects unless expressly stated otherwise. Other explicit and implicit definitions may also be included below.

As described above, there are still many problems to be solved in audio generation. For example, in a conventional timbre customization (also referred to as zero-shot speech synthesis) scheme, a speech prompt is first provided by a user, and then the model may remember the timbre, pronunciation habit, etc. of the speech prompt without being trained, and may use the timbre for speech synthesis.

In this scheme, a language model first predicts according to a text to be synthesized corresponding coarse-grained semantic features, e.g., by using a Hidden-Unit BERT (HuBERT), a bestRQ, a first layer of an end-to-end neural audio codec soundstream, etc. The coarse-grained semantic features are then converted to fine-grained acoustic features using an acoustic model, e.g., using Mel-Spectrum, a Variational Auto Encoder (VAE) hidden layer, later layers of the soundstream, etc. Finally, the acoustic features are converted into a speech waveform using a vocoder, such as a Mel vocoder, an audio VAE, the soundstream, etc. However, when the acoustic model generates fine-grained acoustic features, drawbacks such as poor sound quality, insufficient similarity between of the generated audio and the prompt speech, and insufficient accuracy of pronunciation exist in the above scheme. Furthermore, the above process comprises a plurality of stages, for example, a generation stage from a text to coarse-grained semantic information and a generation stage from coarse-grained semantic information to fine-grained acoustic features, thereby causing a loss of information.

To address at least the above and other potential problems, embodiments of the present disclosure provide a method for generating acoustic features. In this method, a computing device first obtains a target text to be processed and a speech prompt having a target timbre. The speech prompt having the target timbre comprises a prompt text and prompt acoustic features corresponding thereto. Then, the computing device processes the target text and the prompt text to obtain a text embedding for the target text and the prompt text. The computing device may also process prompt acoustic features corresponding to the speech prompt to thereby obtain a corresponding local timbre embedding. Finally, the computing device generates target acoustic features having the target timbre and corresponding to the target text by utilizing the text embedding and the local timbre embedding.

By this method, due to the introduction of text-related input and the timbre of the speech prompt, it is possible to directly generate more similar acoustic features with the speech prompt from the text, improve the timbre and pronunciation accuracy, refrain from using the semantic information, avoid the loss of multi-stage system, and improve the user experience.

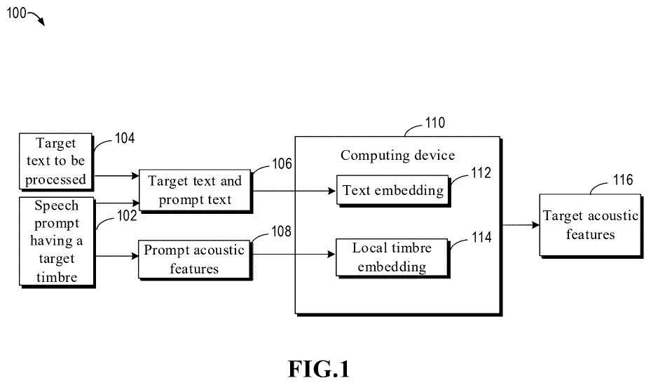

Embodiments of the present disclosure will be described in further detail below with reference to the figures. FIG. 1 illustrates an example environment in which apparatuses and/or methods according to embodiments of the present disclosure may be implemented. In an environment 100, a computing device 110 may process a speech prompt 102 having a target timbre and a target text 104 to be processed and then generate a text embedding 112 and a local timbre embedding 114, respectively in conjunction with a combined target text and prompt text 106 corresponding to the target text to be processed and the speech prompt, and prompt acoustic features 108 corresponding to the speech prompt. Finally, the computing device generates target acoustic features 116 having a target timbre according to the text embedding 112 and the local timbre embedding 114. The target timbre is a timbre existing in a timbre library or a timbre authorized to be used.

Examples of the computing devices 110 include, but are not limited to, personal computers, server computers, hand-held or laptop devices, mobile devices (such as mobile phones, personal digital assistants (PDAs), media players, etc.), multiprocessor systems, consumer electronics, minicomputers, mainframe computers, distributed computing environments that include any of the above systems or devices, and the like.

As shown in FIG. 1, the computing device 110 may be used to obtain the speech prompt 102 having the target timbre and the target text 104 to be processed. The computing device 110 may obtain its corresponding prompt text in any suitable manner. For example, the computing device 110 may extract its corresponding prompt text from the speech prompt 102 and then combine it with the target text 104 to be processed to form the combined target text and prompt text 106. The combination of texts is achieved, for example, by concatenating the prompt text and the target text. The computing device 110 may further determine a text embedding 112 of the target text and the prompt text. In one example, a length of the text embedding 112 is a sum of the lengths of the target text and the prompt text.

In some embodiments, the computing device 110, upon generating the text embedding 112, may use a text encoder to process the target text and the prompt text to obtain the text embedding 112. A model corresponding to the text encoder may be any suitable machine learning model, such as a convolutional neural network with padding, or a transformer structure.

The computing device 110 may also extract the prompt acoustic features 108 from the speech prompt having the target timbre. Thus, the computing device 110 may further use the prompt acoustic features 108 to generate the local timbre embedding 114. In one example, the prompt acoustic features 108 is a Mel-spectrum feature corresponding to the audio information of the speech prompt. In some embodiments, the computing device 110, upon generating the local timbre embedding 114, may use a local timbre encoder to process the prompt acoustic features 108 to generate the local timbre embedding. The local timbre encoder may be any suitable machine learning model. For example, the partial timbre encoder is a fully connected layer structure.

In some embodiments, the local timbre encoder processes each frame in the prompt acoustic features 108 to obtain a corresponding timbre embedding. Then, the computing device 110 processes a plurality of feature frames in the acoustic features 108 to generate the local timbre embedding 114. Alternatively or additionally, the computing device 110 first concatenates the prompt acoustic features 108 with initial information of the target acoustic features corresponding to the target text, and then generates the local timbre embedding 114 by the local timbre encoder, wherein a length of the local timbre embedding 114 is equal to the sum of the lengths of the prompt acoustic features 108 and the target acoustic features. In one example, the initial information of the target acoustic features is all zero.

Finally, the computing device may use the text embedding 112 and local timbre embedding 114 to generate target acoustic features 116. In some embodiments, the target acoustic features 116 corresponds to target text, and the target acoustic features 116 also has a target timbre corresponding to the speech prompt. In some embodiments, the computing device may also generate global timbre embedding according to the prompt acoustic features 108. In an example, the computing device 110 processes the prompt acoustic features 108 as a whole to generate the global timbre embedding, for example, by using a global timbre encoder. Therefore, the target acoustic features may also be generated by the text embedding, the local timbre embedding, and the global timbre embedding. Additionally, during the generation of the target acoustic features, an embedding of noisy acoustic features needs to be further combined to generate the target acoustic features using a combination of the text embedding, the local timbre embedding, the global timbre embedding, and the embedding of the noisy acoustic features. The foregoing examples are only used to describe the present disclosure and are not intended to specifically limit the present disclosure.

In some embodiments, the target acoustic features are generated by applying the text embedding, the local timbre embedding and the embedding of the noisy acoustic features to a self-attention-based diffusion model, e.g., a transformer-based diffusion model. Additionally, the computing device also needs to input the global timbre embedding.

In addition, the computing device may also train the self-attention-based diffusion model. During the training process, the computing device trains the self-attention-based diffusion model using a sample text embedding, a sample global timbre embedding, a sample local timbre embedding, sample noisy acoustic features, and sample acoustic features.

Additionally, the above-described process of generating the acoustic features may be performed by an acoustic model including the self-attention mechanism-based diffusion model, the text encoder, and the local timbre encoder. Additionally, the acoustic model further comprises a global timbre encoder.

In some embodiments, the obtained target acoustic features for the target text may be further input to a vocoder to generate a corresponding speech waveform that may render the target text in the target timbre.

By this method, due to the introduction of text-related input and the timbre of the speech prompt, it is possible to directly generate more similar acoustic features with the speech prompt from the text, improve the timbre and pronunciation accuracy, refrain from using the semantic information, avoid the loss of multi-stage system, and improve the user experience.

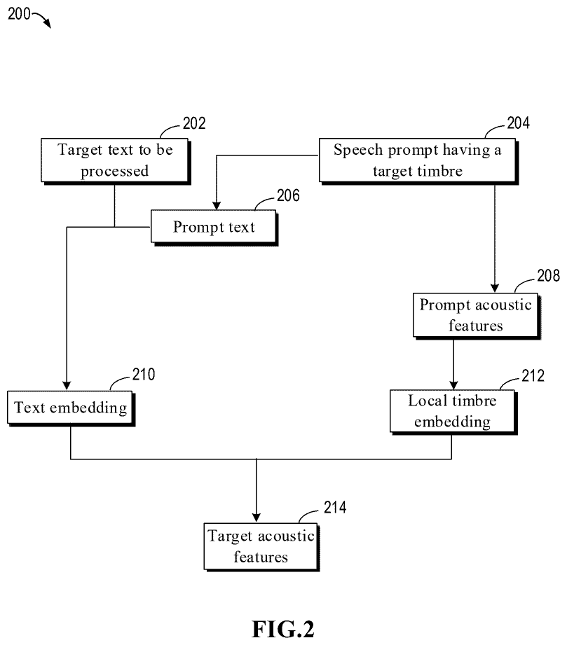

The schematic diagram of an example environment in which apparatuses and/or methods according to embodiments of the present disclosure may be implemented is described above with reference to FIG. 1. Reference is made below to FIG. 2 to describe a schematic diagram of a flow chart of an example of generating acoustic features according to an embodiment of the present disclosure.

As shown in FIG. 2, in example 200, the computing device may receive a target text 202 to be processed and a speech prompt 204 having a target timbre. The computing device may also obtain a prompt text 206 corresponding to the speech prompt 204 having the target timbre. The computing device can also obtain corresponding prompt acoustic features 208 from the audio information of the speech prompt 204.

Then, the computing device uses a text encoder to process a combination of the target text and the prompt text to compute a text embedding 210. Then, the computing device may also use a local timbre encoder to process the prompt acoustic features 208 to generate a local timbre embedding 212.

Finally, the computing device 110 may use a self-attention-based diffusion model to process the text embedding 210 and the local timbre embedding 212 to obtain target acoustic features 214. The target acoustic features 214 is applied to the vocoder to obtain the speech information for the target text having the target timbre.

By this method, due to the introduction of text-related input and the timbre of the speech prompt, it is possible to directly generate more similar acoustic features with the speech prompt from the text, improve the timbre and pronunciation accuracy, refrain from using the semantic information, avoid the loss of multi-stage system, and improve the user experience.

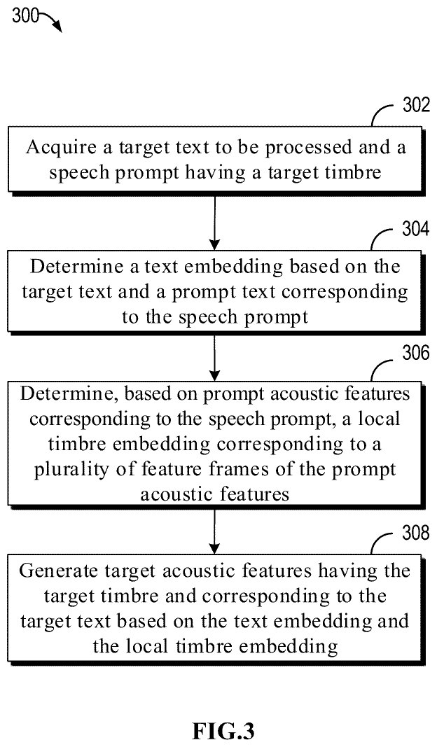

The schematic diagram of the flow chart of an example for generating acoustic features according to an embodiment of the present disclosure is described above with reference to FIG. 2. Reference is made below to FIG. 3 to describe a schematic diagram of an example method for generating acoustic features according to an embodiment of the present disclosure. The process shown in FIG. 3 may be performed at the computing device 110 shown in FIG. 1 or any other suitable computing device.

As shown in FIG. 3, in an example 300, at block 302, the computing device obtains a target text to be processed and a speech prompt having a target timbre. In some embodiments, the target text to be processed contains a complete sentence, e.g., the target text to be processed is “I don't like eating fruit”. In addition, the target timbre contained in the speech prompt is an existing timbre in a timbre library or a timbre authorized to be used.

The computing device then determines a text embedding based on the target text and a prompt text corresponding to the speech prompt at block 304. The target text may be any suitable text information provided to the computing device. In one example, the prompt text is obtained from the speech prompt. In another example, the prompt text is predetermined and the prompt speech is a speech for the prompt text. In one example, lengths of the prompt text and the target text in a temporal dimension are T1 and T2, respectively, and a size of the text embedding is [T1+T2, C], where C denotes a magnitude of a column vector.

In some embodiments, upon generating the text embedding, the computing device 110 obtains the text embedding by applying a combined text of the target text and the prompt text corresponding to the speech prompt to a text encoder. The text encoder may employ any suitable neural network model, such as a convolutional neural network with padding or a transformer structure-based network model, which is not limited here in the present application.

Then, at block 306, the computing device determines, based on prompt acoustic features corresponding to the speech prompt, a local timbre embedding corresponding to a plurality of feature frames of the prompt acoustic features. A length of the local timbre embedding therein may be determined by any suitable method. In one example, the length of the local timbre embedding may be determined based on a statistical word count. In another example, the length of the local timbre embedding may be predicted by a predetermined network model. Since the length corresponding to an acoustic features part of the speech prompt in the local timbre embedding has been determined, the length of target acoustic features part is mainly determined upon determining the length of the local timbre embedding. The foregoing examples are only used to describe the present disclosure and are not intended to specifically limit the present disclosure.

In some embodiments, the plurality of feature frames comprises all the feature frames of the prompt acoustic features, e.g., the speech prompt is a 10-second audio, where each second of audio may correspond to a feature frame. Upon generating the local timbre embedding, the computing device obtains the local timbre embedding by applying the plurality of feature frames of the prompt acoustic features to the local timbre encoder. Additionally, upon generating the local timbre embedding 114, it is also possible to concatenate initial information of the target acoustic features corresponding to the target text after the prompt acoustic features 108 and then process the concatenated information using the local timbre encoder to generate the local timbre embedding corresponding to the lengths of the prompt acoustic features 108 and the target acoustic features. The initial information of the target acoustic features is set to a predetermined value, for example, the initial information is 0.

In some embodiments, the local timbre encoder is a fully connected layer structure. The lengths of the prompt acoustic features and the target acoustic features in a temporal dimension are T3 and T4, respectively, and then the size of the local timbre embedding is [T3+T4, C].

Finally, at block 308, the computing device generates target acoustic features having a target timbre and corresponding to the target text based on the text embedding and the local timbre embedding. The computing device may combine the text embedding and the local timbre embedding to generate a combined embedding, and then the computing device inputs the combined embedding into a self-attention-based diffusion model in the acoustic model to generate the target acoustic features.

In some embodiments, the combined embedding further comprises a global timbre embedding, and the computing device obtains the global timbre embedding by applying the prompt acoustic features to a global timbre encoder. The global timbre encoder generates the global timbre embedding using overall information of the prompt acoustic features. The global timbre encoder outputs a vector, so unlike the local timbre embedding, the global timbre embedding does not have a temporal dimension. In one example, the global timbre embedding is [1,C] and the size of the local timbre embedding is [T3+T4, C]. Thus, the computing device repeats the global timbre embedding T3+T4 times in the temporal dimension to allow it to have the same size as the local acoustic embedding. The structure employed by the global timbre encoder is an Emphasized Channel Attention, Propagation and Aggregation in TDNN Based Speaker Verification (ECAPA-TDNN) structure.

In some embodiments, the computing device also needs to use the embedding of the noisy acoustic features upon generating the combined embedding. The computing device processes the noisy acoustic features using noisy acoustic features encoder to obtain an embedding of the noisy acoustic features. In one example, the noisy acoustic feature encoder may be any suitable machine learning model, which may be, for example, a fully connected layer structure. For example, a length of the noisy acoustic features is T3+T4, and the size of the embedding of the resultant noisy acoustic features is [T3+T4, C].

In some embodiments, when the combined embedding is generated, the local timbre embedding and the embedding of the noisy acoustic features may be summed first. Additionally, the global timbre embedding may also be incorporated. The summed embedding is then concatenated with the text embedding to form a combined embedding with a size [T1+T2+T3+T4, C].

In some embodiments, the acoustic model is used to implement the text embedding, the local timbre embedding, the global timbre embedding, and the embedding of the noisy acoustic features and the target acoustic features described above. The text encoder, the local timbre encoder, the global timbre encoder, and the noisy acoustic feature encoder included in the acoustic model can process the text, the acoustic features and the noisy acoustic features to generate the text embedding, the local timbre embedding, the global timbre embedding and the embedding of the noisy acoustic features. In addition, the self-attention mechanism-based diffusion model in the acoustic model processes the combined embedding to generate the target acoustic features. Additionally, the computing device may also obtain the sample text embedding, the sample global timbre embedding, the sample local timbre embedding, the sample noisy acoustic features, and the sample acoustic features to train the self-attention mechanism-based diffusion model, and may further train the acoustic model in conjunction with the sample text and the sample speech prompt.

In some embodiments, the acoustic model or the self-attention mechanism-based diffusion model may also be fine-tuned according to the user's needs to allow the overall model architecture to obtain a better performance and adapt for more scenarios and different tasks.

By this method, due to the introduction of text-related input and the timbre of the speech prompt, it is possible to directly generate more similar acoustic features with the speech prompt from the text, improve the timbre and pronunciation accuracy, refrain from using the semantic information, avoid the loss of multi-stage system, and improve the user experience.

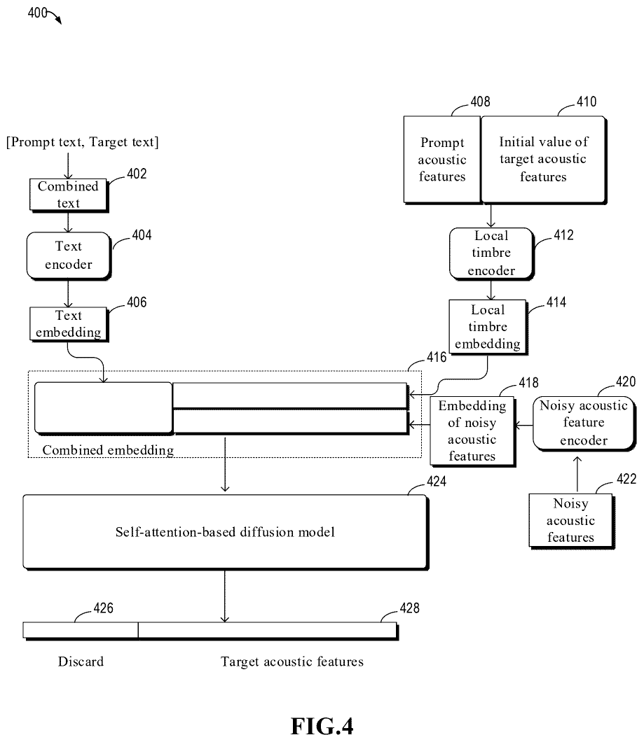

The schematic diagram of the example method for generating the acoustic features according to an embodiment of the present disclosure is described above with reference to FIG. 3. Reference is made below to FIG. 4 to describe a schematic diagram of an example 400 of a model for generating the acoustic features in accordance with an embodiment of the present disclosure.

As shown in FIG. 4, in an example 400, a model architecture comprises a text encoder 404, a local timbre encoder 412, a self-attention-based diffusion model 424, etc. It will be appreciated that the user may also select suitable encoders and other types of models and corresponding model architectures that are capable of implementing the technical solutions in the present disclosure according to the user's own needs, which will not be limited in the present application herein.

In some embodiments, a combined text 402 comprises a prompt text and a target text, a length of the combined text being a sum of a length of the prompt text and a length of the target text. The model structure corresponding to the text encoder is a convolutional neural network with padding, and may also be a transformer structure, which is not limited in the present application. A text embedding 406 corresponding to the combined text 402 is generated by the text encoder.

In some embodiments, the computing device combines prompt acoustic features 408 with an initial value 410 of target acoustic features. Additionally, the initial value 410 of the target acoustic features is represented by a zero-filled placeholder. A local timbre embedding corresponding to the prompt acoustic features 408 and the initial value 410 of the target acoustic features is generated through the local timbre encoder 412. In some embodiments, the combined embedding further comprises an embedding 418 of noisy acoustic features. As can be appreciated, in a model inference process, the computing device takes a noise for the self-attention-based diffusion model 424 as the noisy acoustic features 422 and then obtains the embedding 418 of the noisy acoustic features by a noisy acoustic feature encoder 420. What is described above is only an example describing the present disclosure and is not intended to limit the present disclosure.

In some embodiments, the computing device obtains the target acoustic features 428 by inputting the combined embedding into the self-attention-based diffusion model 424 and discards a portion of information 426. The discarded information comprises information related to the text and information related to the prompt acoustic features, etc. The computing device only retains the information about the generated target acoustic features.

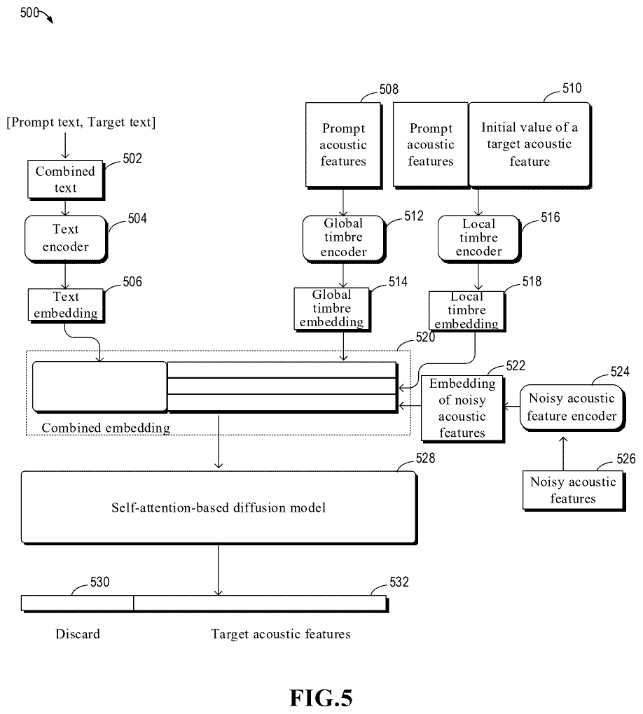

The schematic diagram of an example of a model for generating the acoustic features according to an embodiment of the present disclosure is described above with reference to FIG. 4. Reference is made below to FIG. 5 to describe a schematic diagram of an example 500 of another model for generating acoustic features in accordance with an embodiment of the present disclosure.

As shown in an example 500 shown FIG. 5, similar to the example 400, this embodiment also comprises information such as a combined text 502, prompt acoustic features 508 corresponding to the speech prompt and an initial value 510 of target acoustic features, and meanwhile further comprises a generated text embedding 506 and a local timbre embedding 518, et al. The model architecture also comprises a text encoder 504, a local timbre encoder 516, and a self-attention-based diffusion model 528. In addition, in a model inference process, the computing device may also obtain, via a global timbre encoder 512, a global timbre embedding 514 corresponding to an entirety of the prompt acoustic features. Furthermore, the computing device also obtains a noise for the self-attention-based diffusion model as noisy acoustic features 526 corresponding to the prompt acoustic features and the target acoustic features. Then, the computing device processes the noisy acoustic features 526 using a noisy acoustic feature encoder 524 to generate an embedding 522 of the noisy acoustic features.

In some embodiments, a combined embedding 520 further comprises a global timbre embedding, and the computing device obtains the global timbre embedding by applying the prompt acoustic features to a global timbre encoder. The structure employed by the global timbre encoder is an ECAPA-TDNN structure.

In some embodiments, the combined embedding also comprises an embedding of the noisy acoustic features. The embedding of the noisy acoustic features is obtained by the computing device using the noisy acoustic feature encoder. In one example, the noisy feature encoder is a fully connected layer structure.

In some embodiments, the computing device obtains sample target acoustic features 532 by inputting the combined embedding into the self-attention-based diffusion model 528 and discards a portion of information 530. The discarded information comprises text-related information and information about the prompt acoustic features, etc. The computing device retains the generated target acoustic features.

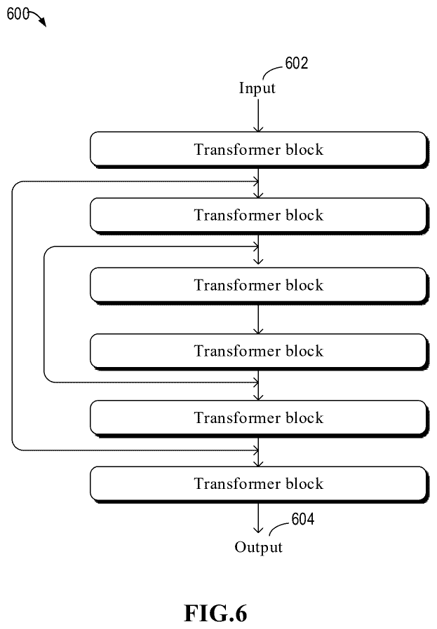

The schematic diagram of the example 500 for generating acoustic features in accordance with an embodiment of the present disclosure is described above with reference to FIG. 5. Reference will be made below to FIG. 6 to describe a schematic diagram of an example of a self-attention mechanism-based diffusion model in a model for generating acoustic features in accordance with an embodiment of the present disclosure.

As shown in FIG. 6, the self-attention-based diffusion model in the acoustic model comprises a plurality of transformer blocks. An input 602 comprises a combined embedding obtained by organically combining a text embedding, a local timbre embedding, a global timbre embedding and an embedding of noisy acoustic features. An output 604 comprises information such as target acoustic features, discarded text-related information and prompt acoustic features.

In some embodiments, the self-attention-based diffusion model comprises a plurality of skip connections. Preceding transformer blocks are connected to later transformer blocks trough the skip connections. An execution efficiency of the self-attention-based diffusion model can be improved through the skip connection function.

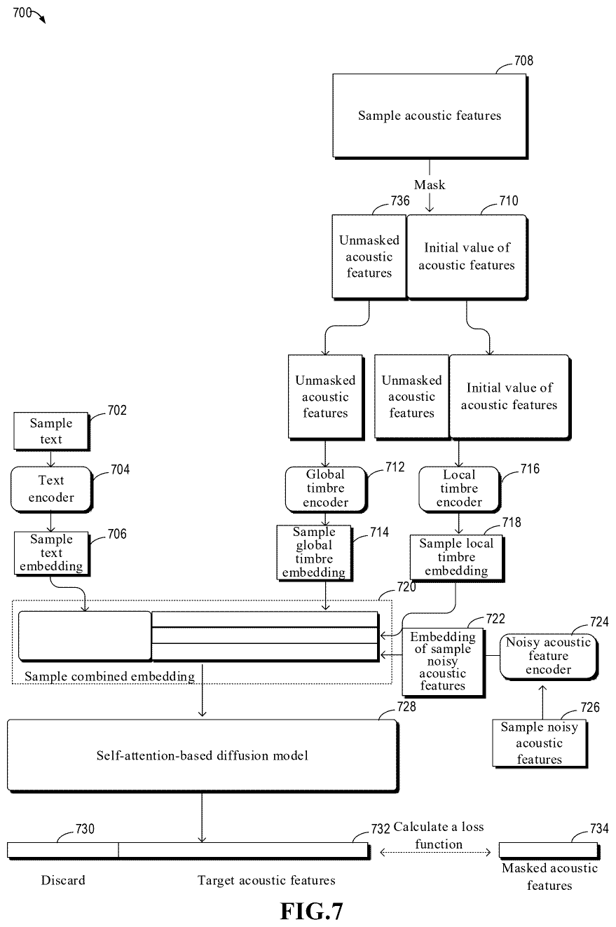

FIG. 6 depicts a schematic diagram of an example of a self-attention mechanism-based diffusion model in a model for generating acoustic features according to an embodiment of the present disclosure. Reference is made below to FIG. 7 to describe a schematic diagram of an example of the training of a model for generating acoustic features in accordance with an embodiment of the present disclosure.

As shown in FIG. 7, similar to the example 500, in an example 700, during model training, there are included a sample text 702, and sample acoustic features 708 of a sample speech prompt corresponding to the sample text 702. In addition, unmasked acoustic features 736 and an initial value 710 of acoustic features corresponding to masked acoustic features can be generated by randomly masking the sample acoustic features 708. In addition, this example further comprises information such as a corresponding sample text embedding 706, a sample global timbre embedding 714, and a sample local timbre embedding 718. The model architecture also comprises a text encoder 704, a global timbre encoder 712, a local timbre encoder 716, and a self-attention-based diffusion model 728. In addition, during model training, the computing device also obtains, through the global timbre encoder 712, a sample global timbre embedding 714 corresponding to an entirety of the unmasked acoustic features 736. Furthermore, the computing device also obtains noisy acoustic features 726 corresponding to the sample acoustic features and applies it to a noisy acoustic feature encoder 724 to generate an embedding 722 of the noisy acoustic features. Finally, the computing device combines the sample text embedding, the sample local timbre embedding, the sample global timbre embedding and the embedding of the sample noisy acoustic features to obtain a sample combined embedding 720.

In some embodiments, the sample target timbre of the sample speech prompt used to train the model is a timbre already in a timbre library or a timbre authorized for use. In one example, the computing device may mask one of the sample acoustic features. In another example, the computing device may mask multiple ones of the sample acoustic features. For example, if the sample speech prompt is “I don't like eating fruits”, the computing device may mask one or more or all of the acoustic features of “I”, “don't like”, “eating” and “fruits” to obtain an initial value for the target acoustic features.

In some embodiments, the computing device obtains sample target acoustic features 732 by inputting the combined embedding into the self-attention-based diffusion model 728 and discards a portion of information 730. The discarded information comprises sample text-related information and information related to the sample speech prompt and the sample prompt acoustic features, and only the generated information related to the sample target acoustic features is retained.

In some embodiments, the computing device also uses a loss function to calculate the obtained target acoustic features and masked acoustic features 734. The acoustic features 732 are a final result obtained from model training. The user may further adjust model parameters by selecting an appropriate loss function to calculate a difference between the obtained acoustic features 732 and the masked acoustic features 734 based on his/her own needs.

By this method, due to the introduction of text-related input and the timbre of the speech prompt, it is possible to directly generate more similar acoustic features with the speech prompt from the text, improve the timbre and pronunciation accuracy, refrain from using the semantic information, avoid the loss of multi-stage system, and improve the user experience.

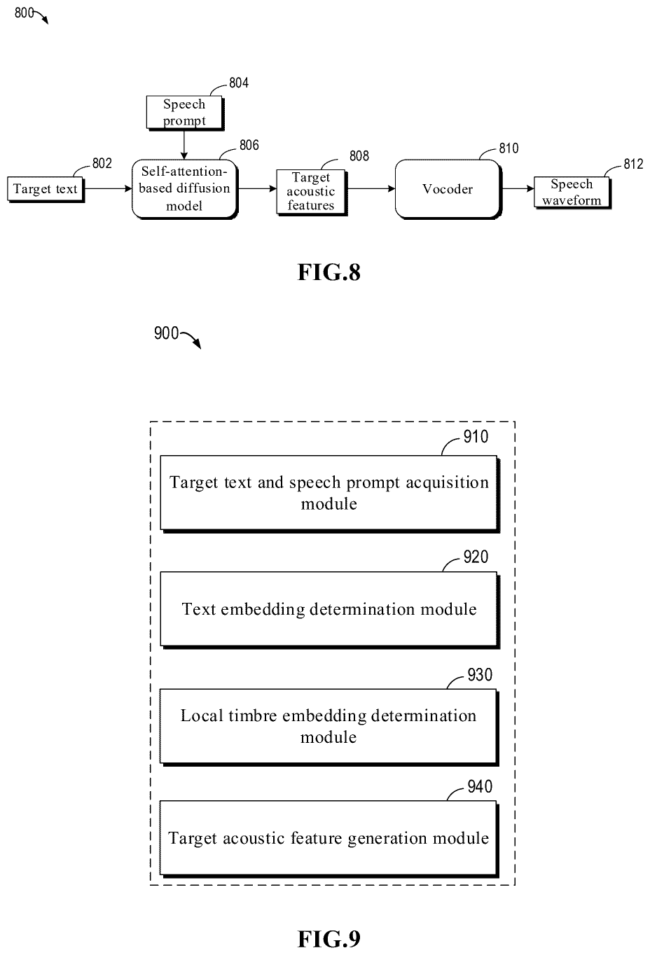

A schematic diagram of an example of an architecture for generating a speech waveform according to an embodiment of the present disclosure will be described below with reference to FIG. 8. In an example 800 as shown in FIG. 8, a computing device first obtains a target text 802 and a speech prompt 804, and the computing device further obtains, according to the target text 802 and the speech prompt 804, a corresponding text embedding, a local timbre embedding, a global timbre embedding and an embedding of noisy acoustic features, respectively, and puts them into a self-attention-based diffusion model 806 to obtain target acoustic features 808 having a target timbre corresponding to the speech prompt. The target timbre is a timbre already existing in a timbre library or a timbre authorized to be used.

Then, the computing device further obtains a speech waveform 812 by applying the target acoustic features 808 to a vocoder 810. In one example, the speech waveform 812 comprises target acoustic features.

FIG. 9 shows a schematic block diagram of an apparatus for generating acoustic features according to an embodiment of the present disclosure. As shown in FIG. 9, an apparatus 900 comprises a target text and speech prompt acquisition module 910 configured to acquire a target text to be processed and a speech prompt having a target timbre; a text embedding determination module 920 configured to determine a text embedding based on the target text and a prompt text corresponding to the speech prompt; a local timbre embedding determination module 930 configured to determine, based on prompt acoustic features corresponding to the speech prompt, a local timbre embedding corresponding to a plurality of feature frames of the prompt acoustic features; and target acoustic features generation module 940 configured to generate target acoustic features having the target timbre and corresponding to the target text based on the text embedding and the local timbre embedding.

In some embodiments, the text embedding determination module 920 comprises: a combined text determination module configured to obtain a combined text by combining the target text and the prompt text; and a text embedding determination module configured to obtain the text embedding based on the combined text.

In some embodiments, the text embedding determination module comprises a text encoder application module configured to obtain the text embedding by applying the combined text to a text encoder.

In some embodiments, the local timbre embedding determination module 930 comprises: a feature frame determination module configured to determine a plurality of feature frames of the prompt acoustic features; and a local timbre encoder application module configured to determine the local timbre embedding of the prompt acoustic features by applying the plurality of feature frames to the local timbre encoder.

In some embodiments, the target acoustic feature generation module 940 comprises: a global timbre embedding determination module configured to determine the global timbre embedding of the prompt acoustic features based on an entirety of the prompt acoustic features; and a target acoustic feature generation module configured to generate target acoustic features having the target timbre and corresponding to the target text based on the text embedding, the local timbre embedding and the global timbre embedding.

In some embodiments, the target acoustic feature generation module further comprises: a noisy acoustic features embedding acquisition module configured to acquire an embedding of noisy acoustic features corresponding to the prompt acoustic features and the target acoustic features; a combined embedding generation module configured to generate a combined embedding by combining the text embedding, the local timbre embedding, the global timbre embedding and the embedding of the noisy acoustic features; and target acoustic features generation module configured to generate target acoustic features having the target timbre and corresponding to the target text based on the combined embedding.

In some embodiments, the combined embedded generation module further comprises: a local timbre embedding length determination module configured to determine a length of the local timbre embedding; a global timbre embedding adjustment module configured to adjust the global timbre embedding based on the length of the local timbre embedding; and a combined embedding generation module configured to generate a combined embedding based on the text embedding, the local timbre embedding, the adjusted global timbre embedding and the embedding of the noisy acoustic features.

In some embodiments, the global timbre embedding adjustment module further comprises: a global timbre embedding repetition module configured to generate the adjusted global timbre embedding by repeating the global timbre embedding based on the length of the local timbre embedding.

In some embodiments, the combined embedding generation module further comprises: a self-attention mechanism-based diffusion model application module configured to generate target acoustic features having the target timbre and corresponding to the target text by applying the combined embedding to the self-attention mechanism-based diffusion model.

In some embodiments, the apparatus 900 further comprises: a sample text and sample speech prompt acquisition module configured to acquire a sample text and a sample speech prompt corresponding to the sample text and having a sample timbre; a sample text embedding determination module configured to determine a sample text embedding based on the sample text; a sample global timbre embedding and sample local timbre embedding generation module configured to generate a sample global timbre embedding and a sample local timbre embedding by masking sample acoustic features of the sample speech prompt; and a self-attention mechanism-based diffusion model training module configured to train the self-attention mechanism-based diffusion model based on the sample text embedding, the sample global timbre embedding, the sample local timbre embedding, sample noisy acoustic features for the sample acoustic features, and the sample acoustic features.

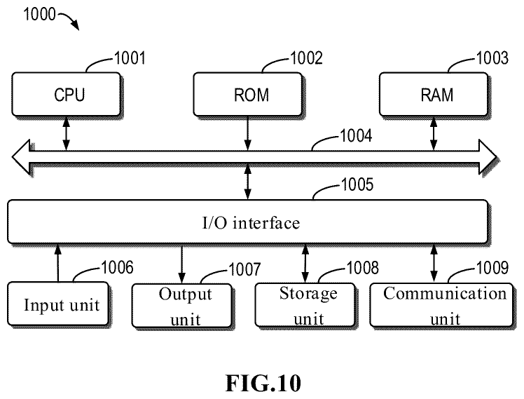

FIG. 10 illustrates a schematic block diagram of an example device 1000 for implementing embodiments of the present disclosure. The computing device 110 in FIG. 1 may be implemented using the device 1000. As shown in FIG. 10, the device 1000 comprises a Central Processing Unit (CPU) 1001 which may perform various suitable acts and processes in accordance with a computer program instruction stored in a Read Only Memory (ROM) 1002 or a computer program instruction loaded from a storage unit 1008 into a Random Access Memory (RAM) 1003. In the RAM 1003, various programs and data needed by the operation of the device 1000 are also stored. The CPU 1001, the ROM 1002, and the RAM 1003 are connected to one another via a bus 1004. An input/output (I/O) interface 1005 is also coupled to the bus 1004.

A plurality of components in the device 1000 are connected to the I/O interface 1005, and include: an input unit 1006, such as a keyboard, a mouse, etc.; an output unit 1007 such as various types of displays, speakers, and the like; a storage unit 1008, such as a magnetic disk, an optical disk, etc.; and a communication unit 1009 such as a network card, a modem, a wireless communication transceiver, etc. The communication unit 1009 allows the device 1000 to exchange information/data with other devices over a computer network such as the Internet and/or various telecommunication networks.

The various methods or processes such as method 300 described above may be performed by the processing unit 1001. For example, in some embodiments, the method 300 may be implemented as a computer software program tangibly embodied on a machine-readable medium, such as storage unit 1008. In some embodiments, part or all of the computer program may be loaded and/or installed on the device 1000 via ROM 1002 and/or communication unit 1009. One or more acts in the method 300 described above may be performed when the computer program is loaded into the RAM 1003 and executed by the CPU 1001.

The present disclosure may relate to methods, apparatuses, systems and/or computer program products. The computer program product may include a computer readable storage medium having computer readable program instructions embodied thereon for performing various aspects of the present disclosure.

The computer-readable storage medium may be a tangible device that can hold and store instructions for use by an instruction execution device. The computer readable storage medium may be, for example but not limited to, an electrical storage device, a magnetic storage device, an optical storage device, an electromagnetic storage device, a semiconductor storage device, or any suitable combination of the above. A non-exhaustive list of more specific examples of the computer readable storage medium comprises the following: a portable computer diskette, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the case of the remote computer, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to implement aspects of the present disclosure.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processing unit of a general-purpose computer, special-purpose computer, or other programmable data processing apparatus to produce a machine, such that the instructions, which executed via the processing unit of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable data processing apparatus or other device to produce a computer implemented process, such that the instructions executed on the computer, other programmable data processing apparatus, or other device implement the functions/acts specified in one or more blocks in the flowcharts and/or block diagrams.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special-purpose hardware and computer instructions.

The depictions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating acoustic features, comprising:
acquiring a target text to be processed and a speech prompt having a target timbre;
determining a text embedding based on the target text and a prompt text corresponding to the speech prompt;
determining, based on prompt acoustic features corresponding to the speech prompt, a local timbre embedding corresponding to a plurality of feature frames of the prompt acoustic features; and
generating target acoustic features having the target timbre and corresponding to the target text based on the text embedding and the local timbre embedding.

2. The method according to claim 1, wherein determining a text embedding based on the target text and the prompt text corresponding to the speech prompt comprises:
obtaining a combined text by combining the target text and the prompt text; and
obtaining the text embedding based on the combined text.

3. The method according to claim 2, wherein obtaining the text embedding based on the combined text comprises:
obtaining the text embedding by applying the combined text to a text encoder.

4. The method according to claim 1, wherein determining, based on prompt acoustic features corresponding to the speech prompt, a local timbre embedding corresponding to a plurality of feature frames of the prompt acoustic features, comprises:
determining the plurality of feature frames of the prompt acoustic features; and
determining the local timbre embedding of the prompt acoustic features by applying the plurality of feature frames to the local timbre encoder.

5. The method according to claim 1, wherein generating target acoustic features having the target timbre and corresponding to the target text based on the text embedding and the local timbre embedding comprises:
determining a global timbre embedding of the prompt acoustic features based on an entirety of the prompt acoustic features; and
generating target acoustic features having the target timbre and corresponding to the target text based on the text embedding, the local timbre embedding and the global timbre embedding.

6. The method according to claim 5, wherein generating target acoustic features having the target timbre and corresponding to the target text based on the text embedding, the local timbre embedding and the global timbre embedding comprises:
acquiring an embedding of noisy acoustic features corresponding to the prompt acoustic features and the target acoustic features;
generating a combined embedding by combining the text embedding, the local timbre embedding, the global timbre embedding and the embedding of the noisy acoustic feature; and
generating target acoustic features having the target timbre and corresponding to the target text based on the combined embedding.

7. The method according to claim 6, wherein generating the combined embedding by combining the text embedding, the local timbre embedding, the global timbre embedding and the embedding of the noisy acoustic features comprises:
determining a length of the local timbre embedding;
adjusting the global timbre embedding based on the length of the local timbre embedding; and
generating a combined embedding based on the text embedding, the local timbre embedding, the adjusted global timbre embedding and the embedding of the noisy acoustic feature.

8. The method according to claim 7, wherein adjusting the global timbre embedding based on the length of the local timbre embedding comprises:
generating the adjusted global timbre embedding by repeating the global timbre embedding based on the length of the local timbre embedding.

9. The method according to claim 8, wherein generating the combined embedding based on the text embedding, the local timbre embedding, the adjusted global timbre embedding and the embedding of the noisy acoustic features comprises:
generating target acoustic features having the target timbre and corresponding to the target text by applying the combined embedding to a self-attention mechanism-based diffusion model.

10. The method according to claim 9, wherein training the self-attention mechanism-based diffusion model comprises:
acquiring a sample text and a sample speech prompt corresponding to the sample text and having a sample timbre;
determining a sample text embedding based on the sample text;
generating a sample global timbre embedding and a sample local timbre embedding by masking sample acoustic features of the sample speech prompt; and
training the self-attention mechanism-based diffusion model based on the sample text embedding, the sample global timbre embedding, the sample local timbre embedding, sample noisy acoustic features for the sample acoustic features, and the sample acoustic features.

11. An electronic device, comprising:
at least one processor; and
a storage device for storing at least one program which, when executed by the at least one processor, causes the at least one processor to:
acquire a target text to be processed and a speech prompt having a target timbre;
determine a text embedding based on the target text and a prompt text corresponding to the speech prompt;
determine, based on prompt acoustic features corresponding to the speech prompt, a local timbre embedding corresponding to a plurality of feature frames of the prompt acoustic features; and
generate target acoustic features having the target timbre and corresponding to the target text based on the text embedding and the local timbre embedding.

12. The electronic device according to claim 11, wherein determine a text embedding based on the target text and the prompt text corresponding to the speech prompt comprises:
obtaining a combined text by combining the target text and the prompt text; and
obtaining the text embedding based on the combined text.

13. The electronic device according to claim 12, wherein obtaining the text embedding based on the combined text comprises:
obtaining the text embedding by applying the combined text to a text encoder.

14. The electronic device according to claim 11, wherein determine, based on prompt acoustic features corresponding to the speech prompt, a local timbre embedding corresponding to a plurality of feature frames of the prompt acoustic features, comprises:
determining the plurality of feature frames of the prompt acoustic features; and
determining the local timbre embedding of the prompt acoustic features by applying the plurality of feature frames to the local timbre encoder.

15. The electronic device according to claim 11, wherein generate target acoustic features having the target timbre and corresponding to the target text based on the text embedding and the local timbre embedding comprises:
determining a global timbre embedding of the prompt acoustic features based on an entirety of the prompt acoustic features; and
generating target acoustic features having the target timbre and corresponding to the target text based on the text embedding, the local timbre embedding and the global timbre embedding.

16. The electronic device according to claim 15, wherein generating target acoustic features having the target timbre and corresponding to the target text based on the text embedding, the local timbre embedding and the global timbre embedding comprises:
acquiring an embedding of noisy acoustic features corresponding to the prompt acoustic features and the target acoustic features;
generating a combined embedding by combining the text embedding, the local timbre embedding, the global timbre embedding and the embedding of the noisy acoustic feature; and
generating target acoustic features having the target timbre and corresponding to the target text based on the combined embedding.

17. The electronic device according to claim 16, wherein generating the combined embedding by combining the text embedding, the local timbre embedding, the global timbre embedding and the embedding of the noisy acoustic features comprises:
determining a length of the local timbre embedding;
adjusting the global timbre embedding based on the length of the local timbre embedding; and
generating a combined embedding based on the text embedding, the local timbre embedding, the adjusted global timbre embedding and the embedding of the noisy acoustic feature.

18. The electronic device according to claim 17, wherein adjusting the global timbre embedding based on the length of the local timbre embedding comprises:
generating the adjusted global timbre embedding by repeating the global timbre embedding based on the length of the local timbre embedding.

19. The electronic device according to claim 18, wherein generating the combined embedding based on the text embedding, the local timbre embedding, the adjusted global timbre embedding and the embedding of the noisy acoustic features comprises:
generating target acoustic features having the target timbre and corresponding to the target text by applying the combined embedding to a self-attention mechanism-based diffusion model.

20. A non-transitory computer readable storage medium having stored thereon a computer program which, when executed by a processor, causes the processor to:
acquire a target text to be processed and a speech prompt having a target timbre;
determine a text embedding based on the target text and a prompt text corresponding to the speech prompt;
determine, based on prompt acoustic features corresponding to the speech prompt, a local timbre embedding corresponding to a plurality of feature frames of the prompt acoustic features; and
generate target acoustic features having the target timbre and corresponding to the target text based on the text embedding and the local timbre embedding.
